(19) United States
(12) Patent Application Publication
(10) Pub. No.: US 2013/0246186 A1
(43) Pub. Date: Sep. 19, 2013

(54) SOCIAL SHOPPING PLATFORM PROVIDING RECOMMENDER DISPLAY AND ADVERTISEMENT PUBLISHING AND SHOPPING METHOD THEREOF

(71) Applicant: BUIDE LIMITED, Taipei (TW)

(72) Inventors: Chia-Chi Chang, Taipei (TW); Cheng-Hsi Juan Lu, Taipei (TW); Sheng-Chuan Yen, Taipei (TW)

(73) Assignee: BUIDE LIMITED, Taipei (TW)

(21) Appl. No.: 13/774,743

(22) Filed: Feb. 22, 2013

(30) Foreign Application Priority Data
Mar. 15, 2012 (TW) 101108968

(51) Int. Cl. G06Q 30/06; G06Q 50/00

(52) U.S. Cl. CPC G06Q 30/0631; G06Q 50/01
USPC 705/14.66; 705/26.7

(57) ABSTRACT

Proposed is a social shopping platform including a social shopping website operatively connected to users through a computer network for allowing users to buy products and share shopping experience with other through the social shopping website. The social shopping website includes a recommender display and selection system for displaying the recommender information of the product and allowing the user to select the recommender of the product when the user is logged into the social shopping website and enters the product shopping page. Also, the social shopping website includes an advertisement publishing system for displaying the users and the information thereof that own the product which is most relevant to the product of which the user desires to buy and displaying the users and the information thereof that reveal the interest to the product which is relevant to the product of which the user desires to buy.

### FIELD OF THE INVENTION

The invention is related to a social shopping platform and the shopping method thereof, and more particularly to a social shopping platform providing recommender display and advertisement publishing and the shopping method thereof.

### BACKGROUND OF THE INVENTION

With the advent of high-speed computers and broadband networks, people used to keep contact with friends and share information with friends through social networks. Also, with the popularity of online shopping, various portal websites and online shopping stores devote themselves to the e-business world to facilitate the computer users to do shopping in their online mall. In order to stimulate the buying spree, the shopping websites often introduces a recommendation system to entice computer users to publish the recommendation hyperlink for goods or the advertising graphic of the goods on his/her personal website in the social network, his/her weblog, or the instant messaging software. In this manner, friends of the publisher or the users who subscribe to the personal website or weblog of the publisher will be attracted to buy the recommended goods. If someone purchases the recommended goods within a predetermined period through the recommendation hyperlink for goods or the advertising graphic of the goods of the computer user, the shopping website will redeem a feedback bonus of a fixed percentage to the recommender.

An obvious example of the aforementioned shopping recommendation system is the affiliate program of the shopping center. The operation of the affiliate program of the shopping center is described below. The computer user first has to register in the shopping center and log into the shipping center as a member of the affiliate program of the shopping center. After the member is logged into the shopping center, the user can select the goods to be recommended by the name of the goods or by the advertising graphic. The system will convert the hyperlink for goods to be recommended into a recommendation hyperlink for goods or an advertising code for the goods. After acquiring the advertising code for the goods or the converted recommendation hyperlink for goods, the user may publish the advertising code for the goods to be recommended or the recommendation hyperlink for goods to be recommended on a social network, such as Facebook, Twitter, Plurk, or Weblog. In addition, the user may publish the advertising code for the goods to be recommended or the recommendation hyperlink for goods to be recommended by instant messaging software (such as Windows Live Messenger), e-mail, or web forum. When someone of interest clicks on the recommendation hyperlink for goods or the advertising graphic of the goods and enrolls in the shopping center, and purchases the goods to be recommended within a predetermined period, the system will record the ID of the recommender and redeem a feedback bonus of a fixed percentage (usually the feedback bonus is 1%-6% of the sale price of the goods) to the recommender. An example of such reference is disclosed in the Published US Patent No. 2009/0228366 to Biris et al.

Nonetheless, the aforementioned state-of-the-art shopping recommendation system still has some drawbacks. First of all, the conventional shopping recommendation system does not display the recommender information to the consumer. Thus, the consumer can not be aware of the information about the recommender. Besides, the conventional shopping recommendation system does not allow the consumer to choose the recommender on his/her own. If the consumer is notified by his/her friends to clicks other's advertising graphic of goods or the hyperlink of the goods, the system will automatically recognize the ID of the recommender to be the user who publishes the advertising graphic of goods or the hyperlink of the goods on which the consumer clicked with, instead of recognizing the ID of the recommender to be the friends of the consumer. Hence, the consumer can not let his/her friends who are desperate to win the feedback bonus to actually earn the feedback bonus. The consumer would be regretted thereby.

Also, the conventional recommendation system does not track the goods owned by the user and does not share the information in connection with the goods owned by the user with the friends of the user. The conventional recommendation system can not retrieve and display the information that is most relevant to the goods of which the user desires to buy from the interactive information between the user and his/her friends, in order to influence the purchase intention of the user. The invention can address these drawbacks.

### SUMMARY OF THE INVENTION

An object of the invention is to provide a social shopping platform providing recommender display and advertisement publishing for displaying the information about the recommender to the consumer.

An object of the invention is to provide a social shopping platform providing recommender display and advertisement publishing for allowing the consumer to choose the recommender.

An object of the invention is to provide a social shopping platform providing recommender display and advertisement publishing for tracking the goods owned by the user, sharing the information in connection with the goods owned by the user with the friends of the user, and retrieving the information that is most relevant to the goods that the user desires to buy from the interactive information between the user and his/her friends, thereby publishing a target advertisement to influence the purchase intention of the user.

A broad aspect of the invention is directed to a social shopping platform including a computer network and a social network. The social network is connected to the computer network and a plurality of users for allowing each user to establish a personal webpage thereon to facilitate the users to communicate and share information with each other. The social shopping platform further includes a social shopping website connected to the social network and the users through the computer network for allowing the user to buy goods and share shopping experiences with each other through the social network. The social shopping website includes a recommender display and selection system for displaying recommender information of goods in the purchase page of the goods when an user logs in the social shopping website and enters the purchase page of the goods, and allowing the user to choose a recommender of the goods. Also, the social shopping platform further includes an advertisement publishing system for tracking and recording goods purchased on the social shopping website by each user in a database and information generated by interactions between each user and other users. When a first user logs in the social shopping website and enters a purchase page of goods, the advertisement publishing system is configured to analyze recordings of the database and display information of user who has the goods whose attributes are most relevant to the goods of which the first user desires to buy, and display information of user who is of interest in the goods whose attributes are most relevant to the goods of which the first user desires to buy.

Another aspect of the invention is directed to a method for purchasing goods on a social shopping website, which includes the steps of: allowing a first user to click a hyperlink for the goods or an advertising graphic of the goods rendered by a second user and enter a purchase page of the goods accordingly; displaying a recommender of the goods on the purchase page of the goods , wherein the recommender is the second user rendering the hyperlink for the goods or the advertising graphic of the goods for the first user to click; allowing the first user to choose the recommender of the goods voluntarily; placing the goods in a shopping cart by a clicking of the first user; and proceeding to a checkout procedure.

Now the foregoing and other features and advantages of the invention will be best understood through the following descriptions with reference to the accompanying drawings, in which:

### BRIEF DESCRIPTION OF THE DRAWINGS

FIG. 1 shows the system architecture of the inventive social shopping platform;

FIG. 2 is a flow chart showing the shopping process involved with the inventive recommender display and selection method;

FIG. 3 exemplarily shows a purchase page of goods including a recommender information display area;

FIG. 4 exemplarily shows a purchase page of goods including a “Change Recommender” display area; and

FIG. 5 is a flow chart showing the advertisement publishing process according to the invention.

### DESCRIPTION OF THE PREFERRED EMBODIMENT

Several exemplary embodiments embodying the features and advantages of the invention will be expounded in following paragraphs of descriptions. It is to be realized that the present invention is allowed to have various modification in different respects, all of which are without departing from the scope of the present invention, and the description herein and the drawings are to be taken as illustrative in nature, but not to be taken as a confinement for the invention.

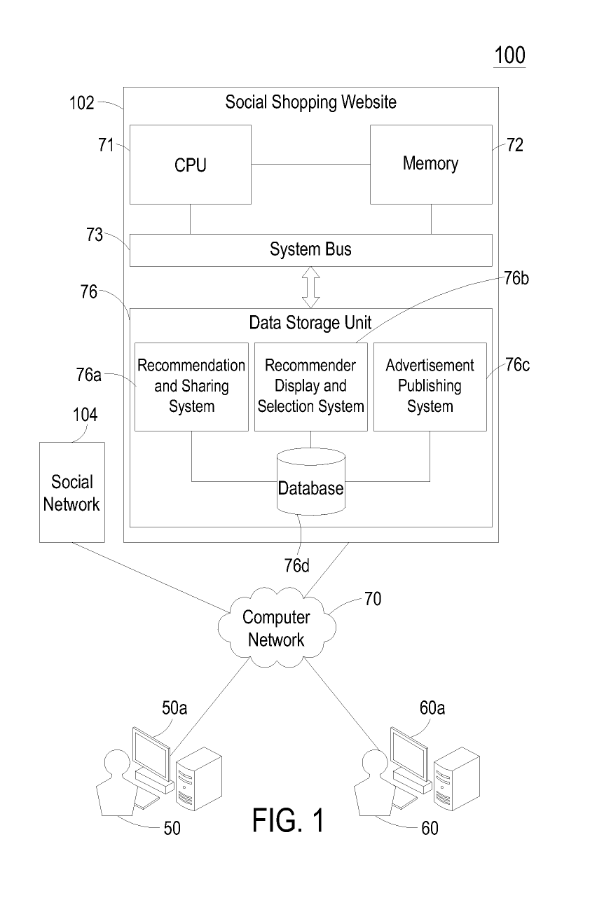

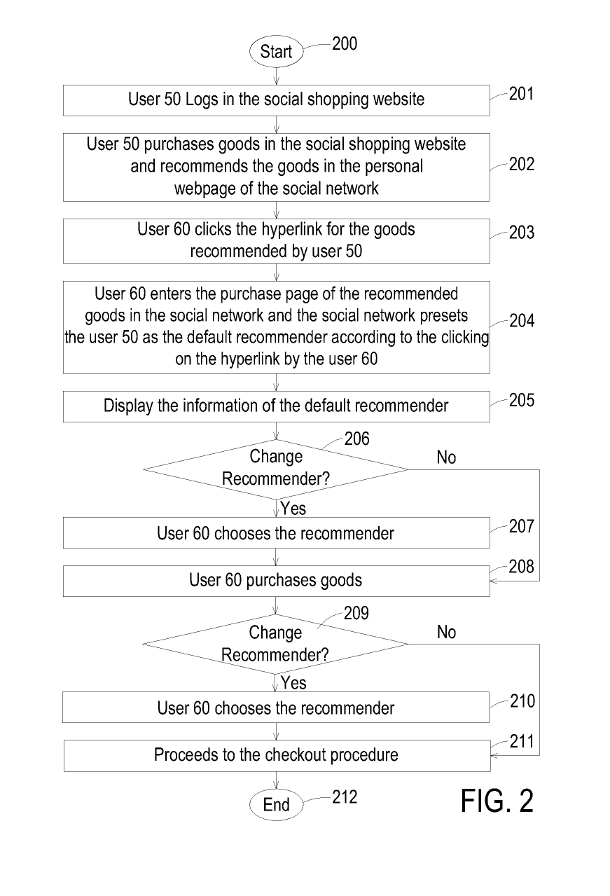

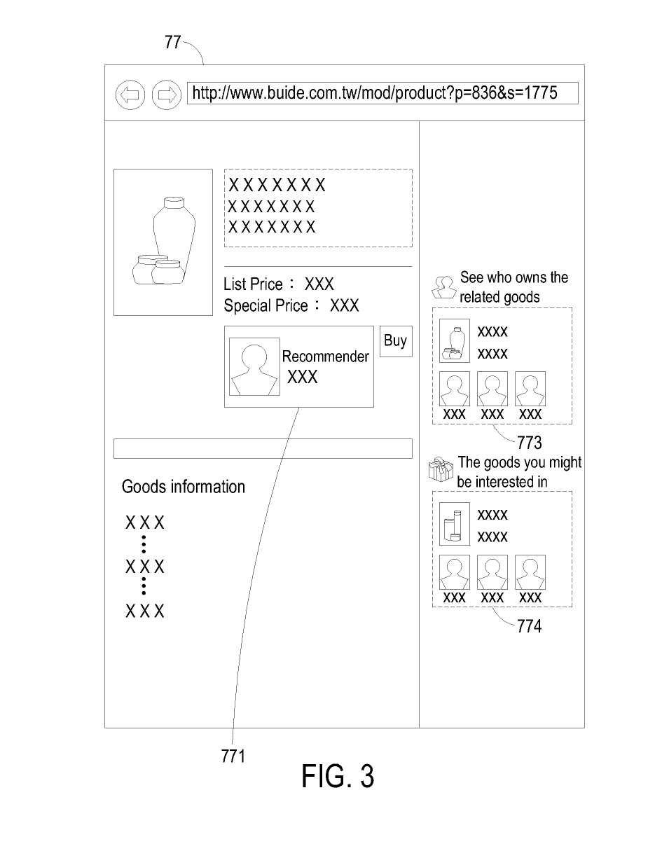

The invention provides a social shopping platform having a recommender display and selection system and an advertisement publishing system. Referring to FIG. 1, in which the system architecture of the inventive social shopping platform 100 is shown. As shown in FIG. 1, the inventive social shopping platform 100 includes a social shopping website 102, a social network 104, and a computer network 70. The social shopping website 102 allows the computer 50a of the user 50 and the computer 60a of the user 60 to register to and log in the social shopping website 102 to do shopping through the computer network 70. The social network 104 allows the computer 50a of the user 50, the computer 60a of the user 60 to register to and log in the social network 104 to communicate with others through the computer network 70. The computer network 70 may be the Internet. The social shopping website 102 is hosted by a server (not shown) including a central processing unit (CPU) 71, a memory 72, a system bus 73, and a data storage unit 76. The CPU 71 is used to perform logical operations and execute program instructions. The memory 72 is used to temporarily store the program instructions and operational data to be executed by the CPU 71. The CPU 71, the memory 72, and the data storage unit 76 are interconnected together by the system bus 73. The social shopping website 102 further includes a recommendation and sharing system 76a, a recommender display and selection system 76b, an advertisement publishing system 76c, and a database 76d. In this embodiment, the recommendation and sharing system 76a, the recommender display and selection system 76b, the advertisement publishing system 76c, and the database 76d are retained in the data storage unit 76. The recommendation and sharing system 76a, the recommender display and selection system 76b, and the advertisement publishing system 76c are implemented by software programs and executed by the CPU 71 to respectively carry out their functions. The social network 104 may include Facebook, Twitter, Plurk, weblogs, or web forums. The user 50 and the user 60 may respectively use the computer 50a and the computer 60a to log in the social network 104 through the computer network 70 and establish a personal webpage in the social network 104 to facilitate the communication and information sharing with friends. The user 50 and the user 60 are friends in the social network 104. Also, the user 50 and the user 60 may use their accounts of the social network 104 to log in the social shopping website 102. Next, the operations of the recommender display and selection system 76b and the advertisement publishing system 76c will be described in detail with reference to FIG. 1, FIG. 2, and FIG. 3.

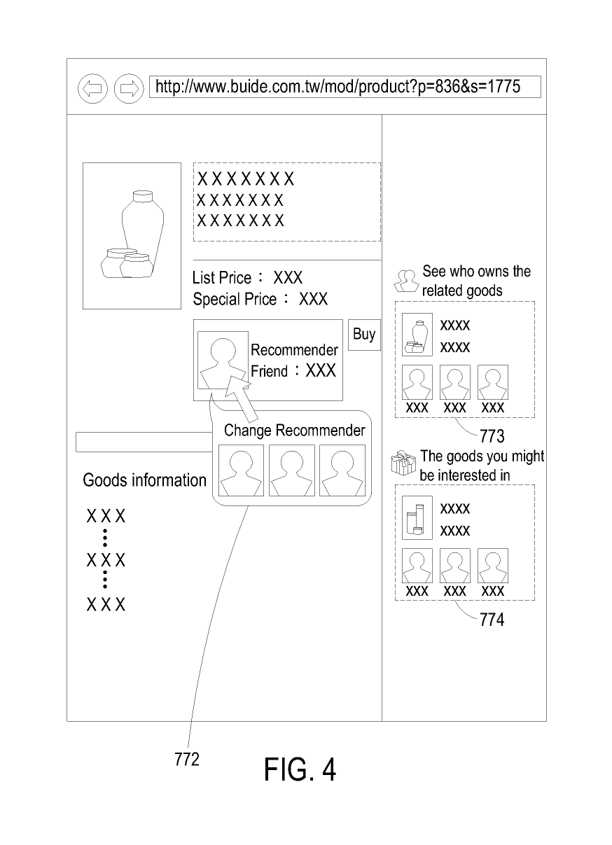

FIG. 2 is a flow chart showing the shopping process involved with the inventive recommender display and selection method. Please refer to FIG. 1 and FIG. 2. First of all, the user 50 logs in the social shopping website 102 by the computer 50a, e.g. by logging in the social shopping website 102 directly or by logging in the social shopping website 102 to the account of the social network 104, as shown in step 201. Next, the user 50 purchases goods in the social shopping website 102, and recommends the purchased goods by articles or recommendation hyperlinks or advertising graphic of the goods on the personal webpage of the social network 104 by the recommendation and sharing function of the social shopping website 102, as shown in step 202. In this step, when the user 50 determines to execute the recommendation and sharing function of the social shopping website 102, the recommendation and sharing system 76a of the social shopping website 102 will automatically generate a recommendation hyperlink embedding the identification of the recommender and record the recommendation hyperlink, and will allow the user 50 to recommend and share the goods in terms of a hyperlink for the goods or an advertising graphic of the goods on the personal webpage of the social network. Next, the user 60 browses the article in connection with the recommended goods posted by the user 50 on his/her personal webpage of the social network 104, and the user 60 is interested in the goods recommended by the user 50 on the personal webpage of the social network 104. Thus, the user 60 clicks the recommendation hyperlink for the recommended goods or clicks the advertising graphic of the recommended goods, as shown in step 203. Next, the user enters the purchase page of the recommended goods on the social shopping website 102, and the social shopping website 102 will automatically determine and record that the hyperlink for the goods or the advertising graphic clicked by the user 60 is published by the user 50 according to the recommended hyperlink embedding the ID of the recommender. Thus, the user 50 is preset as the default recommender, as shown in step 204. Next, the recommender display and selection system 76b is activated to display the information about the default recommender, which may include the identification of the recommender, the nickname of the recommender, and the photograph of the recommender, as shown in step 205. In this embodiment, the user 50 is the default recommender. Hence, the identification of the user 50, the nickname of the user 50, and the photograph of the user 50 will be displayed in the recommender information display area 771 on the purchase page 77, as shown in FIG. 3. Next, the recommender display and selection system 76b allows the user 60 to determine if the recommender will be replaced by others or set as him/her, as shown in step 206. If the user 60 determines that the recommender will be replaced by others or set as him/her, the process continues with step 207 to allow the user 60 to change the recommender, and then the process continues with step 208. In this embodiment, the social shopping website 102 will automatically display the information about other possible recommenders in a “Change Recommender” display area 772 of the purchase page 77, thereby allowing the user 60 to select and change the recommender, as shown in FIG. 4. If the user 60 does not want to change the recommender or set the recommender as him/her, the process continues with step 208. At step 208, the user 60 clicks the “Buy” tab or places the goods in the shopping cart. Next, the recommender display and selection system 76b will be activated again to allow the user 60 to determine if the recommender should be changed or if the recommender should be set as him/her, as shown in step 209. If the user 60 determines that the recommender should be changed or that the recommender should be set as him/her, the process continues with step 210 to allow the user 60 to change recommender, and then the process continues step 211. If the user 60 does not want to change the recommender or set the recommender as him/her, the process continues with step 211. At step 211, the social shopping website 102 drives the user 60 to the checkout procedure to complete the purchase of the goods.

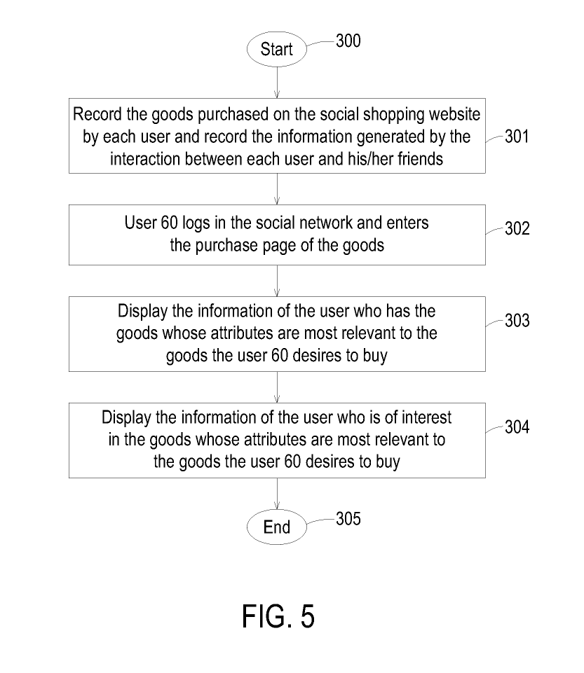

FIG. 5 shows the procedural steps of the advertisement publishing process according to the invention. Please refer to FIG. 1, FIG. 2, and FIG. 5. The advertisement publishing system 76c will track the purchasing operation of each user on the social shopping website 102, and record the goods purchased on the social shopping website 102 by each user. Also, the advertisement publishing system 76c will also track and record the information generated by the interaction between each user and his/her friends (other users). This information includes the messages brought up by the actions of users that show interest or fancy with certain goods. These actions may be perceived through keywords like “have raised a question”, “have answered a question”, “have posted an article and the text of the article shows desire or fondness”. These recordings will be retained in the database 76d, as shown in step 301. When the user 60 logs in the social shopping website 102 and enters the purchase page of the goods of which he/she is of interest of fancy, as shown in step 302, the advertisement publishing system 76c will analyze the recordings in the database 76d and display the information of user who has goods whose attributes are most relevant to the goods of which the user 60 desires to buy. This information is provided for the user 60 as a reference, as shown in step 303. In this embodiment, the advertisement publishing system 76c may display the information of user who has goods whose attributes are most relevant to the goods of which the user 60 desires to buy in a first advertisement area 773 of the purchase page 77. The first advertisement area 773 may be, for example, an advertisement area captioned with a title of “See who owns the related goods”, as shown in FIG. 3 and FIG. 4. Next, the advertisement publishing system 76c will analyze the recordings in the database 76d and display the information of user who is of interest in goods whose attributes are most relevant to the goods of which the user 60 desires to buy. This information is provided for the user 60 as a reference, as shown in step 304. In this embodiment, the advertisement publishing system 76c may display the information of user who is of interest in goods whose attributes are most relevant to the goods of which the user 60 desires to buy in a second advertisement area 774 of the purchase page 77. The second advertisement area 774 may be, for example, an advertisement area captioned with a title of “The goods you might be interested in”, as shown in FIG. 3 and FIG. 4. The whole process ends up with step 305.

It is noteworthy that the first advertisement area 773 and the second advertisement area 774 may be published in another social shopping website (not shown), the website of others (or a third-party website, which is not shown in the drawings), or published in a personal webpage of the social network 104 (such as Facebook page of others, Twitter page of others, Plurk page of others, weblogs, or web forums) through the computer network 70. The website that is set to publish the advertisement is connected with the social shopping network 102 and allows two-way information communication in connection with goods and users. For example, when an user browses the weblogs of others and finds some commentary information and photographic information of certain goods on the weblog, the first advertisement area 773 and the second advertisement area 774 may be set to be displayed on the weblog. In this manner, the recommending and target advertisement is attained in order to influence the shopping preference and purchase intention of the user, so that the user connects the social shopping network 102 to proceed with online shopping.

In conclusion, the invention proposes a social shopping platform providing recommender display and advertisement publishing and the shopping method thereof. The social shopping platform 100 includes a social shopping website 102, a social network 104, and a computer network 70. The social shopping website 102 includes a data storage unit, which hosts a recommender display and selection system and an advertisement publishing system. When an user 60 clicks the recommendation link posted by an user 50 on the social network 104 and enters the purchase link of the social shopping website 102, the recommender display and selection system displays the recommender information (user 50) on the purchase page of the goods and allows the user 60 to choose others or him/her as the recommender. When a first user enters the purchase page of goods on the social shopping website 102, the advertisement publishing system can display the information of user who has the same goods or related goods or display the information of user who is of interest of fancy in the goods of which the first user desires to buy. Thus, the user can determine who will be the recommender voluntarily. That is, the user can decide who will receive the feedback bonus as the purchase process of the goods has been completed. Also, when the user enters the purchase page of goods, items owned by friends of the user will be tracked. Such information will be provided for the user, so that the user can share the shopping experience with friends. Also, the information generated by the interaction between the user and his/her friends will be scrutinized, and the information that is most relevant to the goods of which the user desires to buy is published in the form of target advertisement in order to influence the purchase intention of user.

While the invention has been described in terms of what are presently considered to be the most practical and preferred embodiments, it is to be understood that the invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the invention which is defined by the appended claims.

What is claimed is:

1. A social shopping platform comprising:
a computer network;
a social network connected to the computer network and a plurality of users for allowing each user to establish a personal webpage thereon to facilitate the users to communicate and share information with each other; and
a social shopping website connected to the social network and the users through the computer network for allowing the users to buy goods and share shopping experiences with each other through the social network;
wherein the social shopping website includes a recommender display and selection system for displaying recommender information of goods in the purchase page of the goods when an user logs in the social shopping website and enters the purchase page of the goods, and allowing the user to choose a recommender of the goods.

2. The social shopping platform according to claim 1 wherein the social network includes Facebook, Twitter, Plurk, weblogs, or web forums.

3. The social shopping platform according to claim 1 wherein the social shopping website further includes:
a database; and
an advertisement publishing system for tracking and recording goods purchased on the social shopping website by each user in the database and information generated by interactions between each user and other users, and when a first user logs in the social shopping website and enters a purchase page of goods, analyzing recordings of the database and displaying information of user who has the goods whose attributes are most relevant to the goods of which the first user desires to buy, and displaying information of user who is of interest in the goods whose attributes are most relevant to the goods of which the first user desires to buy.

4. The social shopping platform according to claim 3 wherein the advertisement publishing system is configured to display the information of user who has the goods whose attributes are most relevant to the goods of which the first user desires to buy and the information of user who is of interest in the goods whose attributes are most relevant to the goods of which the first user desires to buy in another social shopping website, a third-party website, or a personal webpage of the social network.

5. The social shopping platform according to claim 3 wherein the social shopping website includes a data storage unit configured to host the recommender display and selection system, the database, and the advertisement publishing system.

6. The social shopping platform according to claim 3 further comprising a recommendation and sharing system configured to generate a recommendation hyperlink embedding an identification of a recommender to allow the recommender to recommend and share goods by a hyperlink for the goods or an advertising graphic of the goods on the personal webpage of the social network.

7. The social shopping platform according to claim 6 wherein the social shopping website is configured to automatically determine and record the hyperlink for the goods or the advertising graphic of the goods clicked by an user according to the recommendation hyperlink embedding an identification of the recommender, and preset the recommender as a default recommender.

8. The social shopping platform according to claim 1 wherein the recommender information includes an identification of the recommender, a nickname of the recommender, and a photograph of the recommender, and wherein the recommender information is displayed in a recommender information display area of the purchase page of the goods.

9. A method of purchasing goods on a social shopping website, comprising the steps of:
allowing a first user to click a hyperlink for the goods or an advertising graphic of the goods rendered by a second user and enter a purchase page of the goods accordingly;
displaying a recommender of the goods on the purchase page of the goods, wherein the recommender is the second user rendering the hyperlink for the goods or the advertising graphic of the goods for the first user to click;
allowing the first user to choose the recommender of the goods voluntarily;
placing the goods in a shopping cart by a clicking of the first user; and
proceeding to a checkout procedure.

10. The method according to claim 9 wherein after the step of placing the goods in a shopping cart by a clicking of the first user, the method further includes a step of:
allowing the first user to choose the recommender of the goods voluntarily again.

11. The method according to claim 9 wherein after the step of allowing a first user to click a hyperlink for the goods or an advertising graphic of the goods rendered by a second user and enter a purchase page of the goods accordingly, the method further comprising the steps of:
displaying information of user who has goods whose attributes are most relevant to the goods of which the first user desires to buy; and
displaying information of user who is of interest in goods whose attributes are most relevant to the goods of which the first user desires to buy.
